(19) United States
(12) Patent Application Publication
(10) Pub. No.: US 2002/0171072 A1
(43) Pub. Date: Nov. 21, 2002

(54) Two speed windlass

(76) Inventor: Lin Tso-Kuo, Fengyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/859,432

(22) Filed: May 18, 2001

(51) Int. Cl. B66D 1/14

(52) U.S. Cl. 254/345; 254/346

(57) ABSTRACT

A two speed windlass includes a driving shaft, a clutch and a planetary gear speed reducing mechanism. The clutch is used to connect the driving shaft to the planetary gear speed reducing mechanism to control the speed of the driving shaft The speed of the two speed windlass, thus, can be reduced by the speed reducing mechanism. The integral speed also can remain the same by synchronously driving the speed reducing mechanism.

### BACKGROUND OF THE INVENTION

1. Field of the Invention

The present invention relates to a two speed windlass, and, more particularly, to a two speed windlass utilizing a clutch to control the connection or separation between a driving shaft and a speed reducing mechanism so as to perform a two speed function.

2. Description of the Related Prior Art

A conventional windlass having speed reducing mechanism is shown in FIG. 4 including an internal gear 71, an input shaft 72, a planetary gear 73 and an output gear 74.

### SUMMARY OF THE INVENTION

However, it is found a disadvantage in the subject matter of the above-mentioned prior art that it is configured to reduce the speed only without the function of changing speed.

Another disadvantage found is that it does not perform the function of changing the rotation direction.

Thus, there is still a need for improving the subject matter of prior art in terms of providing a windlass which can change its speed and/or rotation direction.

Therefore, an object of the present invention is to provide a two speed windlass which can quickly reels in the rope first and then slowly reels in the rope without obviously steppedly reducing the speed.

To accomplish the object of the present invention, the present invention provides a two speed windlass which includes a power source. A driving shaft having a first end is connected to the power source. A hollow shaft has a first end to allow the driving shaft to pass through. The hollow shaft is located on a stand by a first bearing and has a second bearing to allow the driving shaft to rotatably pass through. A clutch is mounted between the hollow shaft and the power source and the clutch is allowed to rotate together with the hollow shaft when the clutch actuates. A planetary gear speed reducing mechanism has a circular gear. The planetary gear speed mechanism is connected to the hollow shaft by the circular gear. The driving shaft extends through the planetary gear speed reducing mechanism to reduce the driving speed from the driving source. A delivery shaft is driven by the planetary gear speed reducing mechanism and drives a reel so as to rotate together with the reel.

### BRIEF DESCRIPTION OF THE DRAWINGS

The other advantages and/or benefits caused by the present mention will become patently apparent after reading the following detailed description of an illustrative preferred embodiment of the present invention together with referring to the associated drawings in which:

FIG. 1 is a cross-sectional view of the preferred embodiment of the two speed windlass in accordance with the present invention;

FIG. 2 is the other cross-sectional view of the preferred embodiment of the two speed windlass in accordance with the present invention;

FIG. 3 is the other cross-sectional view of the preferred embodiment of the two speed windlass in accordance with the present invention; and

FIG. 4 is an exploded view of a conventional windlass.

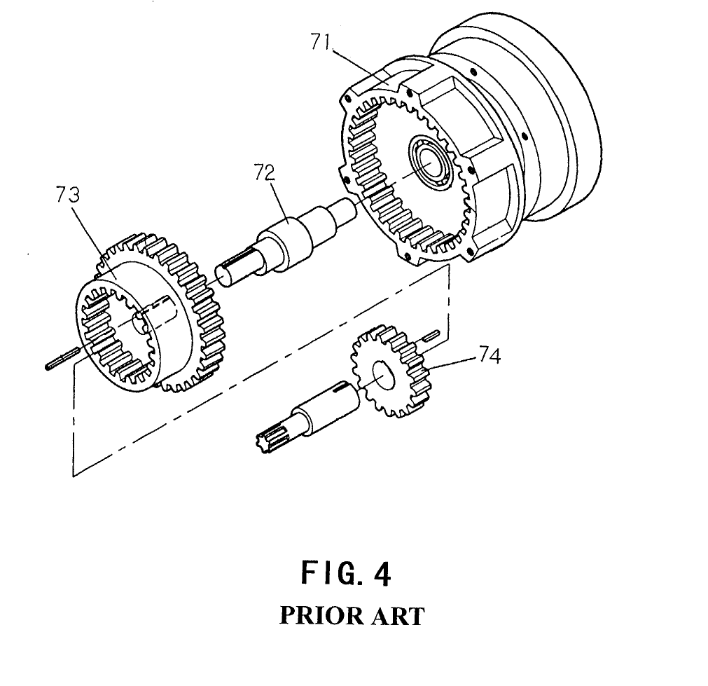

### DETAILED DESCRIPTION OF THE PREFERRED EMBODIMENT

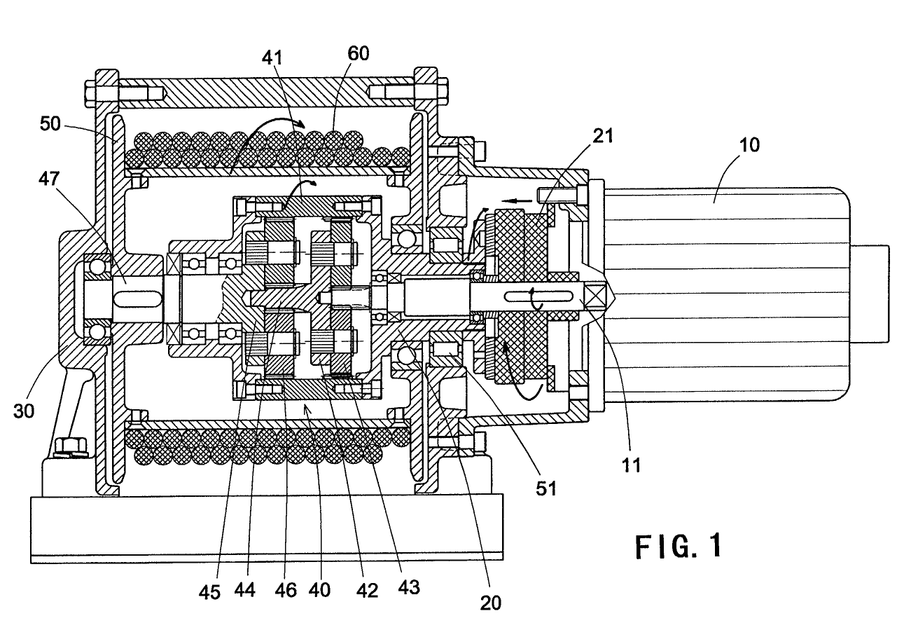

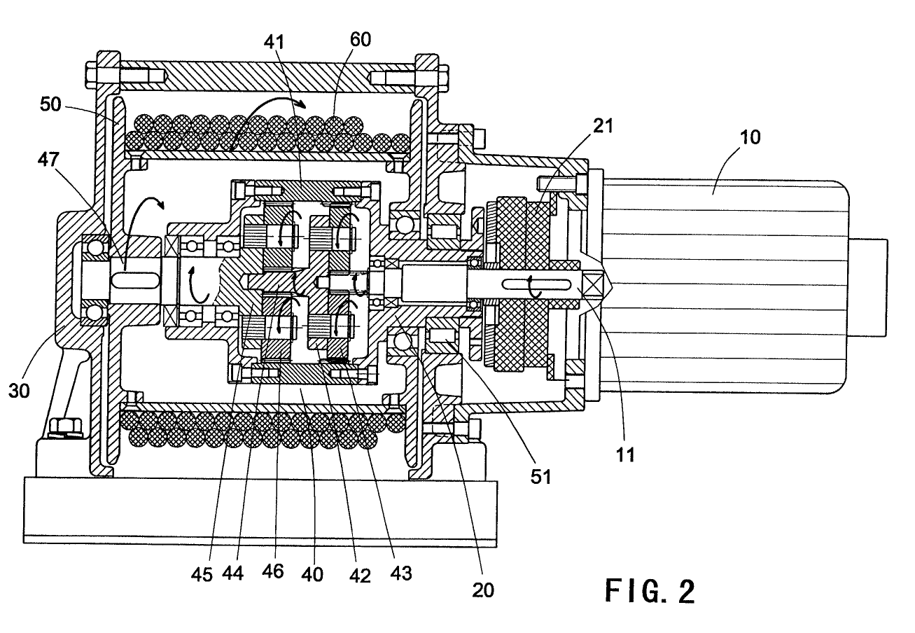

With reference to FIGS. 1 and 2, a preferred embodiment of the two speed windlass in accordance with the present invention includes a power source 10, a driving shaft 11, a hollow shaft 20, a clutch 21, a planetary gear speed reducing mechanism 40 and a delivery shaft 47.

The power source 10, for example, is embodied by a motor.

The driving shaft 11 has a first end connected to the power source 10 so that the driving shaft 11 can rotate in clockwise or counterclockwise by the power source 10. The driving shaft 11 also has a second end opposite to the first end.

The hollow shaft 20 has a first end to allow the second end of the driving shaft 11 to pass therethrough. The hollow shaft 20 is located on a stand 30 by a first bearing. The hollow shaft 20 also has a second bearing therein to allow the driving shaft 11 to rotatably pass therethrough. The hollow shaft 20 further has a second end opposite to the first end.

The clutch 21 is an electromagnetic clutch in this embodiment. The clutch 21 is mounted between the first end of the hollow shaft 20 and the power source 10. The clutch 10 rotates together with the driving shaft 11. When the clutch 10 actuates, the clutch 10 will be attracted toward the hollow shaft 20. Thus, the hollow shaft 20 will rotate together with the driving shaft 11 by the clutch 10.

The planetary gear speed reducing mechanism 40 has a circular gear 41 encircling therearound. The circular gear 41 is embodied by an internal gear in this preferred embodiment. A first side of the planetary gear speed reducing mechanism 40 facing the power source 10 is connected to the second end of the hollow shaft 20 by a side of the circular gear 41 facing the power source 10. The second end of the driving shaft 11 extends through the center of the planetary gear speed reducing mechanism 40 to reduce the driving speed from the driving source 10.

The planetary gear speed reducing mechanism 40 further has a second side opposite to the first side.

The delivery shaft 47 is driven by the second side of the planetary gear speed reducing mechanism 40 and drives a reel 50. Thus, the delivery shaft 47 rotates together with the reel 50. A rope 60 is wound on the outer surface of the reel 50.

More particularly, the planetary gear speed reducing mechanism 40 further includes a first planetary gear combination 43 and a second planetary gear combination 46.

The first planetary gear combination 43 includes multiple planetary gears and a first rotating arm 43. Each multiple planetary gear of the first planetary gear combination 43 tangentially engages with the circular gear 41.

Each planetary gear is pivotally mounted on a corresponding end of the first rotating arm 43 at a face of the rotating arm 43 facing the driving shaft 11. The first rotating arm 43 further has a connecting gear rod 44 protruding from a face of the first rotating arm 13 opposite to the driving shaft 11.

The second planetary gear combination 46 is connected to the first planetary gear combination 43 by the connecting gear rod 44 of the first planetary gear combination 43.

The second planetary gear combination 46 has multiple planetary gears and a second rotating arm 45. Each planetary gear of the second planetary gear combination 46 tangentially engages with the circular gear 43. Each planetary gear of the second planetary gear combination 46 is pivotally mounted on a corresponding end of the second rotating arm 45 at a face of the second rotating arm 45 opposite to the driving shaft 11. The second rotating arm 45 further has a delivery shaft 47 protruding from a face of the first rotating arm 45 opposite to the driving shaft 11.

More particularly, the reel 50 encircles an outer side of the speed reducing mechanism 40. The reel 50 accommodates the hollow shaft 20 which is located between the clutch 21 and the speed reducing mechanism 40 from an end of the reel 50 opposite to the delivery shaft 47 by a single rotating bearing 51.

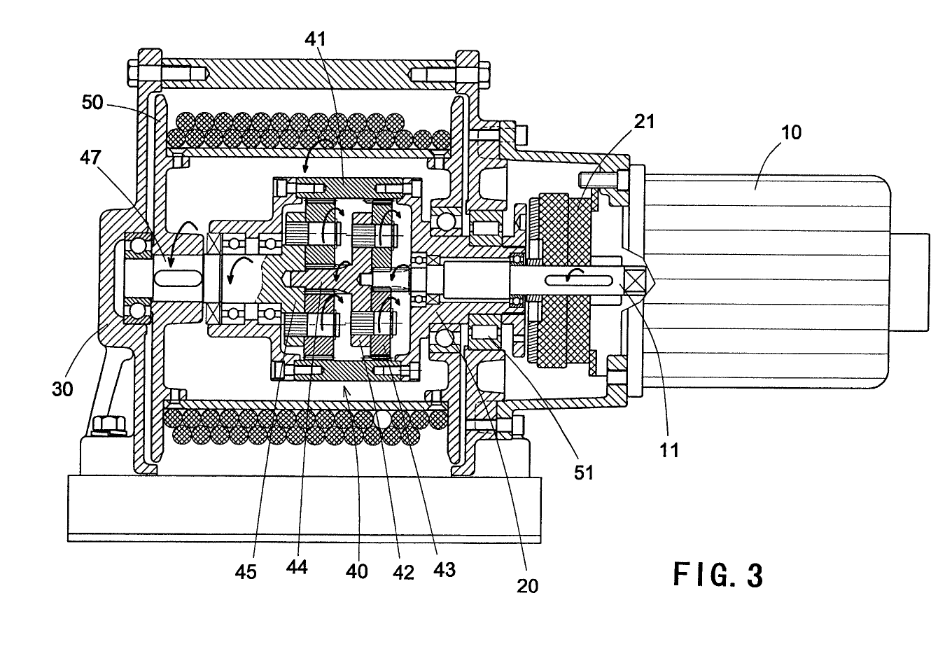

Referring to FIG. 3, with the preferred embodiment of the two speed windlass in accordance with the present invention, when the rope 60 is reeled out from the reel 50, the driving shaft 11 is allow to rotate in the desired direction. In this case, the clutch 21 does not actuate. Thus, the power output from the driving shaft 11 is delivered into the speed reducing mechanism 40. Through speed reducing engagement among the first planetary combination 43, the second planetary combination 46 and the circular gear 41 together with the speed reducing function from the first rotating arm 42 and the second rotating arms 45, the rotating speed of the delivery shaft 47 is reduced. Thus, the reel 50 is controlled to slowly reel out the rope 60.

With reference to FIGS. 1 and 2 again, in case that the rope is desired to be reeled in after the rope is reeled out with a certain length, the power source is so controlled that the rotation direction is different from that when the rope 60 is reeled out. Therefore, The rope 60 is reeled in to encircle the reel 50 in the direction in need (see FIG. 1). At this moment, since the clutch 21 actuates, the driving shaft 11 rotates together with hollow shaft 20. Therefore, the reel-in speed of the rope 60 is the same as the rotation speed of the power source 10 and driving shaft 11. In this manner, the rope 60 is reeled in by a fast speed.

However, occasionally depending on the differently requisite applications or situations, the reel-in speed of the rope 60 should not be too fast or the reel-in speed of the rope 60 should be changed from fast to slow. In such a situation, the clutch 10 according to the present invention is designed to separate from the hollow shaft 20 rendering that the hollow shaft 20 becomes an independent individual. Therefore, the power from the driving shaft 11 is delivered into speed reducing mechanism 40. Through the speed reducing engagement among the first planetary gear combination 43, the second planetary gear combination 46 and the circular gear 41 together with speed reducing function of the first rotating arm 42 and the second rotating arm 45, the speed of the driving shaft 47 is reduced. Thus, the reel 50 is controlled under a slow speed situation and the rope 60 is slowly reeled in.

Having thus detailedly described the preferred embodiment of the present invention, it will become apparently to those skilled in the art that the detailed description of the preferred embodiment of the present invention is illustrative only and thus various modifications, changes and substitutions can be made without departing from the spirit of the following claims of the present invention. All of such modifications, changes and substitution as stated above are still within the scope of the present invention.

What is claimed is:

1. A two speed windlass, comprising
a power source;
a driving shaft having a first end connected to the power source and a second end opposite to the first end;
a hollow shaft having a first end to allow the second end of the driving shaft to pass therethrough, the hollow shaft being located on a stand by a first bearing and having a second bearing therein to allow the driving shaft to rotatably pass therethrough, the hollow shaft further having a second end opposite to the first end;
a clutch mounted between the first end of the hollow shaft and the power source and rotating together with the driving shaft so as to allow the clutch to rotate together with the hollow shaft when the clutch actuates;
a planetary gear speed reducing mechanism having a circular gear encircling therearound and a first side connected to the second end of the hollow shaft by a side of the circular gear, the second end of the driving shaft extending through a center of the planetary gear speed reducing mechanism to reduce a driving speed from the driving source, and the planetary gear speed reducing mechanism having a second side opposite to the first side; and
a delivery shaft driven by the second side of the planetary gear speed reducing mechanism and driving a reel so as to rotate together with the reel, and a rope-like body winding a surface of the reel.

2. The two speed windlass as claimed in claim 1, wherein
the planetary gear speed reducing mechanism further comprises
a first planetary gear combination including
multiple planetary gears tangentially engaging with the circular gear and a first rotating arm, and each planetary gear pivotally mounted on a corresponding end of a first rotating arm at a face of the rotating arm facing the driving shaft, the first rotating arm further having a connecting gear rod protruding from a face of the first rotating arm opposite to the driving shaft; and
a second planetary gear combination connected to the first planetary gear combination by the connecting gear rod of the first planetary gear combination, and including
multiple planetary gears tangentially engaging with the circular gear and each planetary gear pivotally mounted on a corresponding end of a second rotating arm at a face of the rotating arm opposite to the driving shaft, the second rotating arm further having a delivery shaft protruding from a face of the first rotating arm opposite to the driving shaft.

3. The two speed windlass as claimed in claim 1, wherein
the reel encircles an outer side of the speed reducing mechanism, and the reel accommodates the hollow shaft located between the clutch and the speed reducing mechanism from an end of the reel opposite to the delivery shaft
